(19) United States
(12) Patent Application Publication
(10) Pub. No.: US 2014/0373615 A1
(43) Pub. Date: Dec. 25, 2014

(54) MODEL MOTION SYSTEM FOR A VEHICLE MODEL

(71) Applicant: Auto Research Center, LL, Indianapolis, IN (US)

(72) Inventors: Andrew Gunselman, Indianapolis, IN (US); Mike Wright, Zionsville, IN (US); Michael W. Camosy, Indianapolis, IN (US)

(21) Appl. No.: 14/309,016

(22) Filed: Jun. 19, 2014

Related U.S. Application Data
(60) Provisional application No. 61/836,793, filed on Jun. 19, 2013.

(51) Int. Cl. G01M 9/06; G01M 9/08

(52) U.S. Cl. CPC G01M 9/062; G01M 9/08
USPC 73/147

(57) ABSTRACT

A model motion system for providing controlled motion of a vehicle model with wheels on is provided. The model motion system includes a pitch system coupled to the vehicle model with wheels on to control a pitch range of motion of the vehicle; a roll system coupled to the vehicle model with wheels on to control a roll range of motion of the vehicle; and a yaw system coupled to the vehicle model with wheels on to control a yaw range of motion of the vehicle. The pitch system, the roll system, and the yaw system control the respective ranges of motion of the vehicle model with wheels on.

### CROSS REFERENCE TO RELATED APPLICATION

This application claims the benefit of and incorporates by reference herein the disclosure of U.S. Ser. No. 61/836,793, filed Jun. 19, 2013.

### TECHNICAL FIELD OF THE DISCLOSED EMBODIMENTS

The embodiments herein generally relate to vehicle models and, more particularly, to a model motion system for a vehicle model having wheels on.

### BACKGROUND OF THE DISCLOSED EMBODIMENTS

Vehicle models are often tested in wind tunnels to test the aerodynamics of the vehicle. Often, vehicle models are tested using model motion systems that account for the motion of the vehicle in three degrees of freedom, namely pitch, roll, and yaw. Model motion systems typically include arms that attach to the model vehicle at the location of the wheels. In these systems, the wheels are in position relative to the vehicle model, but they are not attached to the vehicle model. Rather, the wheels are on the ends of external bars that position the wheels where they should be with respect to the vehicle model. Since the wheels are not attached to the model, and the bars are retaining the wheels, the testing does not provide a true aerodynamic picture of a real-world situation. Unfortunately, without the wheels attached to the vehicle model, the aerodynamics of the vehicle cannot be accurately tested, thereby limiting the test results of the vehicle model.

### SUMMARY OF THE DISCLOSED EMBODIMENTS

The disclosed embodiments relate to a system for providing controlled motion, in the three modes of pitch, roll, and yaw, of a scale vehicle model with wheels on in a wind tunnel test facility. The system includes ranges of motion that can be achieved, either independently or in combination, to move the model to a desired position in a repeatable manner. The system is compact, allowing installation into a wide variety of models including narrow single-seater racing cars. The aerodynamic, and dynamic, forces generated during testing using the system result in a minimum amount of deflection of the system. The system reduces the loss of testing time and can be installed in models in a reasonable time. Additionally, the force measuring balance of the system can be removed without complete disassembly of the system.

In one embodiment, the system provides yaw motion of +/−14°, roll motion of +/−5°, and pitch motion of +/−5°. Motion may be achieved in some embodiments by the use of stepper motors driving through gear reduction to multiply torque. In some embodiments, the pitch motion drive employs a worm-drive gearbox that transmits torque almost exclusively in one direction only. The installation of this worm-drive gearbox, and mating ball-screw, is arranged so as to inherently control the large pitch moment forces generated when testing race car models, for example. The system includes provisions in some embodiments for the bearings to be installed in a preloaded condition, thus increasing their installation stiffness.

In one embodiment, a model motion system for providing controlled motion of a vehicle model with wheels on is provided, wherein the model motion system includes a pitch system coupled to the vehicle model with wheels on to control a pitch range of motion of the vehicle; a roll system coupled to the vehicle model with wheels on to control a roll range of motion of the vehicle; and a yaw system coupled to the vehicle model with wheels on to control a yaw range of motion of the vehicle. The pitch system, the roll system, and the yaw system control the respective ranges of motion of the vehicle model with wheels on.

In one embodiment, a model motion system for providing controlled motion of a vehicle model with wheels on is provided, wherein the model motion system includes a control system. The model motion system also includes a pitch system coupled to the vehicle model with wheels on and having a pitch drive to control a pitch range of motion of the vehicle; a roll system coupled to the vehicle model with wheels on and having a roll drive to control a roll range of motion of the vehicle; and a yaw system coupled to the vehicle model with wheels on and having a yaw drive to control a yaw range of motion of the vehicle. The control system electronically controls the pitch drive, the roll drive, and the yaw drive to control the respective ranges of motion of the vehicle model with wheels on.

In one embodiment, a method for providing controlled motion of a vehicle model with wheels on is provided. The method includes coupling the vehicle model with wheels on to a pitch system having a pitch drive; coupling the vehicle model with wheels on to a roll system having a roll drive; and coupling the vehicle model with wheels on to a yaw system having a yaw drive. The method also includes electronically controlling the pitch drive, the mll drive, and the yaw drive with a control system to control the respective ranges of motion of the vehicle model with wheels on.

Other embodiments are also disclosed.

### BRIEF DESCRIPTION OF DRAWINGS

The embodiments described herein and other features, advantages and disclosures contained herein, and the manner of attaining them, will become apparent and the present disclosure will be better understood by reference to the following description of various exemplary embodiments of the present disclosure taken in conjunction with the accompanying drawing, wherein:

FIG. 1 illustrates a perspective view of a model motion system formed in accordance with an embodiment.

FIG. 2 illustrates a perspective view of a model motion system formed in accordance with an embodiment.

FIG. 3 illustrates a perspective view of a model motion system formed in accordance with an embodiment.

FIG. 4 illustrates a perspective view of a step in the yaw bearing preload.

FIG. 5 illustrates a perspective view of a step in the yaw bearing preload.

FIG. 6 illustrates a perspective view of a step in the yaw bearing preload.

FIG. 7 illustrates a perspective view of a step in the yaw bearing preload.

FIG. 8 illustrates a perspective view of a step in the yaw bearing preload.

FIG. 9 illustrates a perspective view of a step in the yaw bearing preload.

FIG. 10 illustrates a perspective view of a step in the yaw bearing preload.

FIG. 11 illustrates a perspective view of a step in the yaw bearing preload.

FIG. 12 illustrates a perspective view of a step in the roll bearing preload.

FIG. 13 illustrates a perspective view of a step in the roll bearing preload.

FIG. 14 illustrates a perspective view of a step in the roll bearing preload.

FIG. 15 illustrates a perspective view of a step in the roll bearing preload.

FIG. 16 illustrates a perspective view of a step in the roll bearing preload.

FIG. 17 illustrates a perspective view of a step in the roll bearing preload.

FIG. 18 illustrates a perspective view of a step in the roll bearing preload.

FIG. 19 illustrates a perspective view of a step in the yaw/roll system assembly.

FIG. 20 illustrates a perspective view of a step in the yaw/roll system assembly.

FIG. 21 illustrates a perspective view of a step in the yaw/roll system assembly.

FIG. 22 illustrates a perspective view of a step in the yaw/roll system assembly.

FIG. 23 illustrates a perspective view of a step in the yaw drive installation.

FIG. 24 illustrates a perspective view of a step in the yaw drive installation.

FIG. 25 illustrates a perspective view of a step in the yaw drive installation.

FIG. 26 illustrates a perspective view of a step in the yaw drive installation.

FIG. 27 illustrates a perspective view of a step in the yaw drive installation.

FIG. 28 illustrates a perspective view of a step in the yaw pitch assembly.

FIG. 29 illustrates a perspective view of a step in the yaw pitch assembly.

FIG. 30 illustrates a perspective view of a step in the yaw pitch assembly.

FIG. 31 illustrates a perspective view of a step in the yaw pitch assembly.

FIG. 32 illustrates a perspective view of a step in the yaw pitch assembly.

FIG. 33 illustrates a perspective view of a step in the yaw pitch assembly.

FIG. 34 illustrates a perspective view of a step in the pitch system bearing preload.

FIG. 35 illustrates a perspective view of a step in the pitch system bearing preload.

FIG. 36 illustrates a perspective view of a step in the pitch system bearing preload.

FIG. 37 illustrates a perspective view of a step in the pitch system bearing preload.

FIG. 38 illustrates a perspective view of a step in the pitch mechanism assembly.

FIG. 39 illustrates a perspective view of a step in the pitch mechanism assembly.

FIG. 40 illustrates a perspective view of a step in the pitch mechanism assembly.

FIG. 41 illustrates a perspective view of a step in the pitch mechanism assembly.

FIG. 42 illustrates a perspective view of a step in the pitch mechanism assembly.

FIG. 43 illustrates a perspective view of a step in the pitch mechanism assembly.

FIG. 44 illustrates a perspective view of a step in the pitch system installation.

FIG. 45 illustrates a perspective view of a step in the pitch system installation.

FIG. 46 illustrates a perspective view of a step in the pitch drive installation.

FIG. 47 illustrates a perspective view of a step in the roll drive installation.

FIG. 48 illustrates a perspective view of a step in the roll drive installation.

FIG. 49 illustrates a perspective view of a step in the roll drive installation.

FIG. 50 illustrates a perspective view of a step in the roll drive installation.

FIG. 51 illustrates a perspective view of a step in the compressed air feed installation.

FIG. 52 illustrates a method for providing controlled motion of a vehicle model.

### DETAILED DESCRIPTION OF THE DISCLOSED EMBODIMENTS

The features and advantages of this disclosure, and the manner of attaining them, will be more apparent and better understood by reference to the following descriptions of the disclosed methods and systems, taken in conjunction with the accompanying drawings. The components in the figures are not necessarily to scale, emphasis instead being placed upon illustrating the principles of the disclosure. Moreover, in the figures like referenced numerals designate corresponding parts throughout the different views, but not all reference numerals are shown in each of the figures.

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. Alterations and modifications in the illustrated device, and further applications of the principles of the invention as illustrated therein, as would normally occur to one skilled in the art to which the invention relates are contemplated, are desired to be protected. Such alternative embodiments require certain adaptations to the embodiments discussed herein that would be obvious to those skilled in the art.

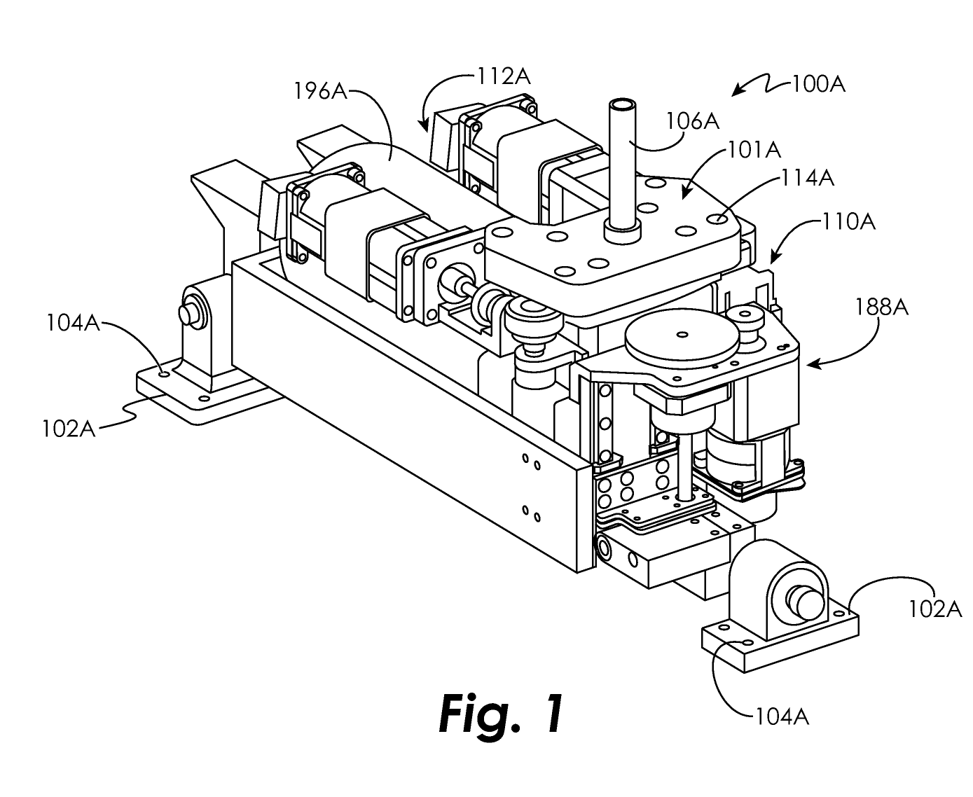

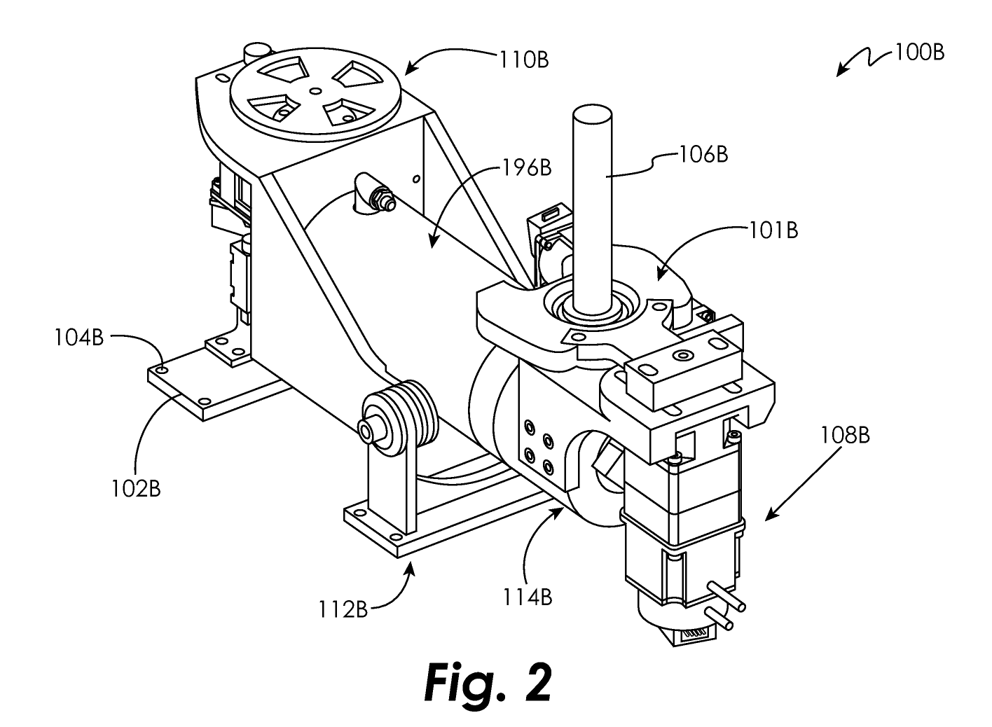

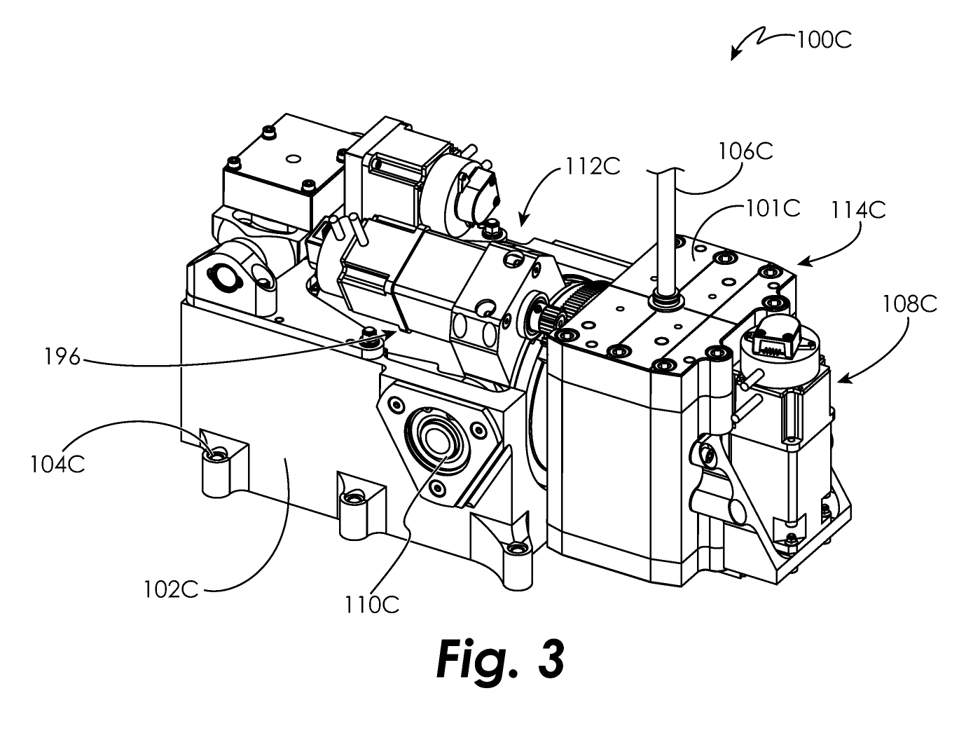

FIG. 1 illustrates a model motion system 100A formed in accordance with an embodiment. FIG. 2 illustrates a model motion system 100B formed in accordance with another embodiment. FIG. 3 illustrates a model motion system 100C formed in accordance with another embodiment. The model motion systems 100 are configured to be installed within a wheels-on vehicle model (not shown). The wheels-on vehicle model includes model wheels mounted to the model vehicle in the positions they would occupy on the real-world vehicle, as opposed to the wheels being separate from the model vehicle and positioned adjacent to the model vehicle using external mounting bars. The system 100 provides controlled motion of the vehicle model in three modes of pitch, roll, and yaw. The system is secured to a frame of the vehicle model. In one embodiment, the system housing 102 includes various bolt holes 104 so that the housing 102 can be secured to the frame of a vehicle model of any size and configuration. A sting 106 is joined to the top 101 of the system housing 102 and extends through the top of the vehicle model. The sting 106 holds the system in a stationary position within the wind tunnel.

The vehicle is moved in three degrees of freedom, pitch, roll, and yaw, by the model motion system 100. In some embodiments, the system 100 includes stepper motors driving through gear reduction to multiply torque and move the vehicle model in the three degrees of freedom. A yaw system 108 includes a motor that turns the model vehicle to the left and right sides with respect to a centerline of the vehicle. The system 100 provides yaw motion of +/−14° in one embodiment. A pitch system 110 may include a stepper motor that turns a worm-drive gearbox to drive a ball screw rod that pushes the car up and down with respect to a plane that is parallel to the floor of the wind tunnel. The worm-drive gearbox transmits torque almost exclusively in one direction only. The system provides pitch motion of +/−5° in one embodiment. A roll system 112 enables the vehicle model to rotate about a longitudinal axis of the vehicle. The system provides roll motion of +/−5° in one embodiment. The ranges of motion can be achieved either independently or in combination such that the forces generated during testing result in a minimum amount of deflection of the system. It will be appreciated from the present disclosure that other ranges of yaw, roll and/or pitch motion may be provided in other embodiments.

Each of the yaw system 108, the pitch system 110, and the roll system 112 may be electronically controlled by a control system 114 within the model motion system 100. The control system 114 sends electronic signals to the motors of the yaw system 108, pitch system 110 and the roll system 112 to change the position of the vehicle model within the wind tunnel. Data related to the aerodynamics of the vehicle model is acquired by the control system 114. In particular, a force measuring balance 196 retrieves and stores the data. In one embodiment, the force measuring balance 196 is a 6-axis force measurement balance (available from Aerodynamic Test Equipment Ltd, Crown Technical Centre, Burwash Road, Heathfield, East Sussex, TN21 8QZ, UK). The force measuring balance 196 may be removed from the system 100 without complete disassembly of the system 100. Accordingly, the force measuring balance 196 may be independently connected to a computer system to analyze the data without removal of the entire system 100. Alternatively, the data can be transferred to a computer system without removal of the force measuring balance 196, for example, through the use of a wired data connection, a wireless data connection, or a removable drive such as a flash drive or the like.

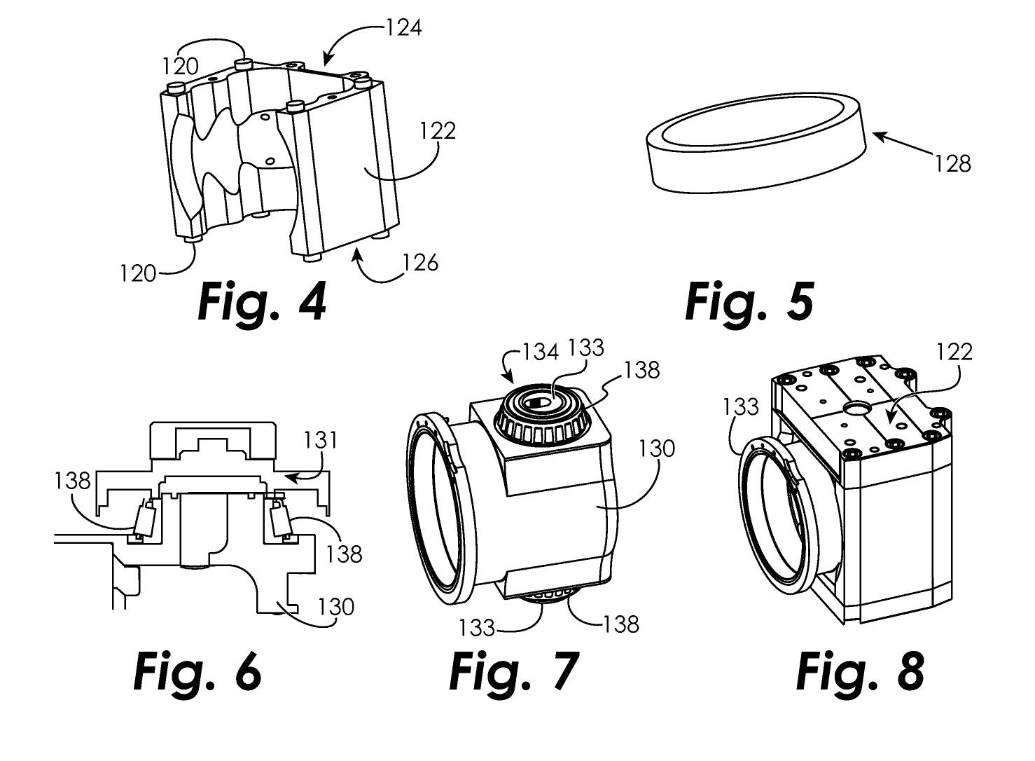

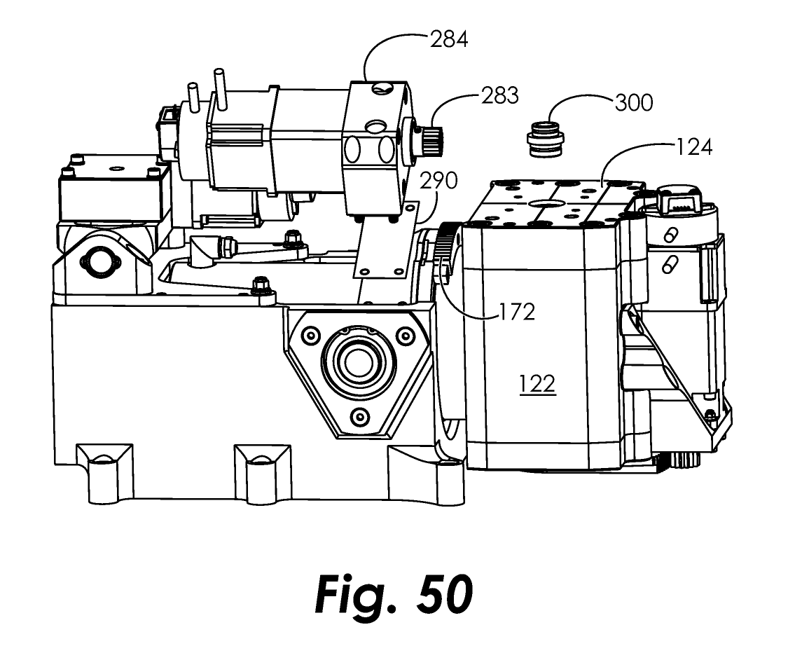

FIGS. 4-51 illustrate the assembly process for the model motion system 100C illustrated in FIG. 3. During assembly, bearings 138 are installed in a preloaded condition to increase installation stiffness. FIGS. 4-11 illustrate the steps of a yaw bearing preload, wherein eight ring dowels 120 are pressed into a yaw box 122 with four of the ring dowels 120 being pressed into the top 124 of the yaw box 122 and four of the ring dowels being pressed into the bottom 126 of the yaw box 122, as shown in FIG. 4. Outer track surfaces 128 for taper roller bearings 138 are minimally linished, as shown in FIG. 5. The minimally linished outer track surfaces 128 are utilized to provide adequate spacing within the yaw bearing for the permanent tracks that will be installed during loading. Being minimally linished, the tracks 128 can be freely inserted into a yaw housing 130. The tapered bearings 138 are attached to protrusions 133 formed in a top 134 and a bottom 136 of the yaw housing 130. The tapered bearings 138 are seated on the top 134 and bottom 136 of the yaw housing 130 using an installation tool 131 (shown in FIG. 6). The yaw box 122 is assembled around the yaw housing 130 with the linished outer bearing tracks 128 installed without preload shims, as shown in FIG. 8.

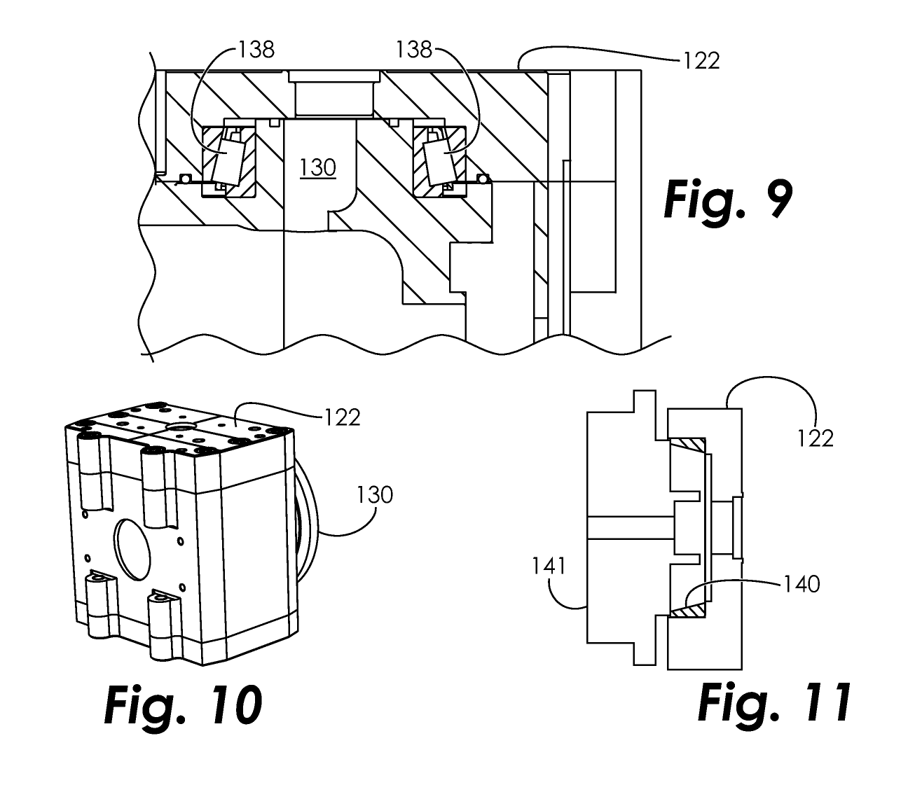

A float of the yaw housing 130 within the yaw box 122 is measured. In one embodiment, the yaw housing 130 is shimmed within the yaw box 122 to establish approximately a 0.001″ tolerance at preload, as shown in FIG. 9. Equal shim thicknesses may be utilized under the top and bottom bearings 138 in order to center the yaw housing 130 within the yaw box 122. The tolerance may be adjusted by stacking up of the parts with a minimum of one approximately 0.004″ shim on top and bottom, and a maximum shim stack of approximately 0.016″ on top and bottom in one embodiment.

The yaw box 122 is then disassembled to remove the linished tracks 128, as shown in FIG. 10. Standard tracks 140 are fit within the yaw box 122 with preload shims. The standard tracks 140 are seated using an installation tool 141, as shown in FIG. 11. The yaw box 122 is not reassembled around the yaw housing 130 at this stage.

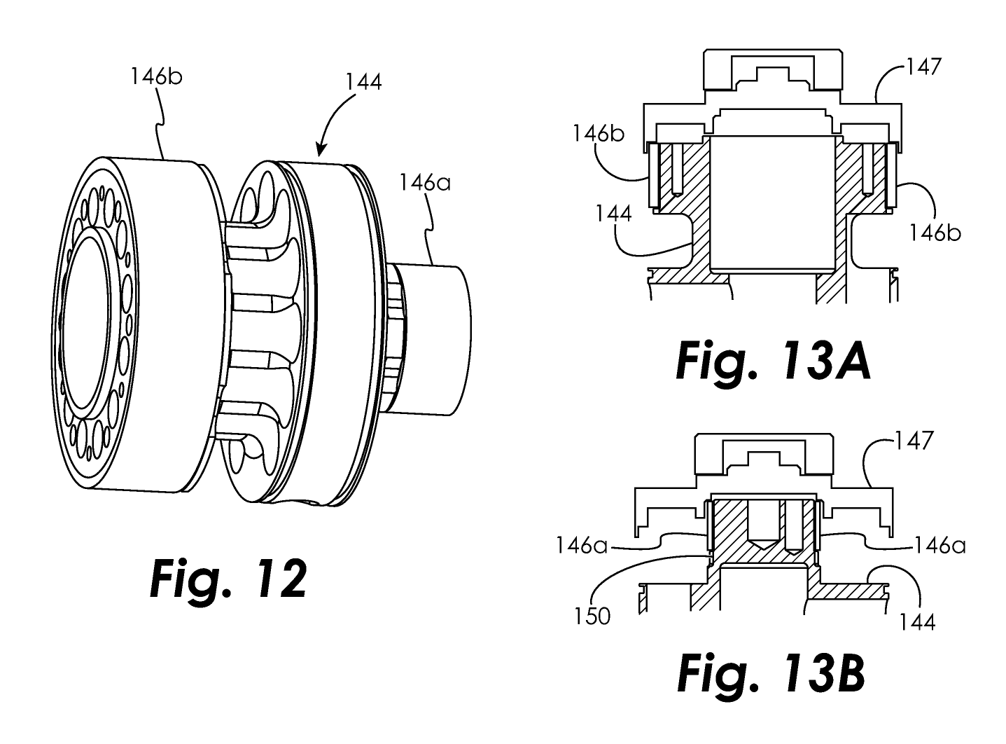

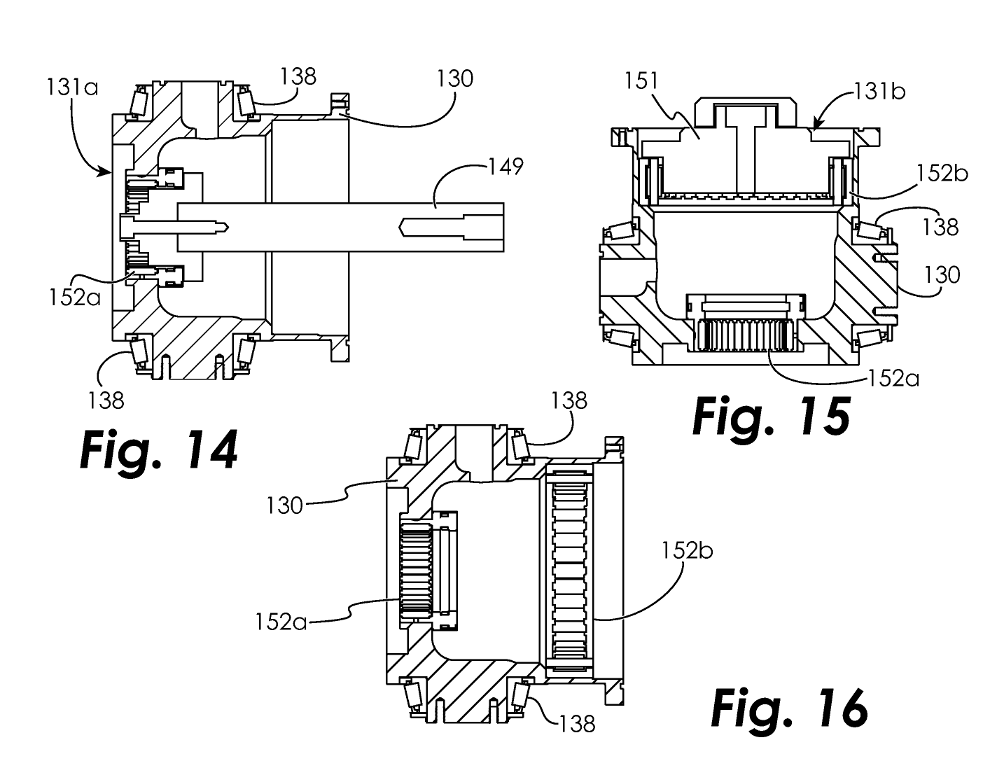

FIGS. 12-18 illustrate the preloading of a roll bearing 144 (shown in FIG. 12) according to one embodiment. Inner races 146a and 146b of the roll bearing 144 are seated on the roll bearing 144 using an installation tool 147, as shown in FIG. 13. During seating, both inner races 146a and 146b are abutted to retaining shoulders 150 of the roll bearing 144. FIGS. 14-16 illustrate the assembly of outer races 152a and 152b into the yaw housing 130. After the roll bearing 144 is installed into the yaw housing 130, the outer races 152a and 152b are configured to provide a contact surface for the inner races 146a and 146b, respectively. As illustrated in FIG. 14 the outer race 152a is installed into a first opening 131a of the yaw housing 130 using an installation tool 149. As illustrated in FIG. 15, the outer race 152h is installed into a second opening 131b of the yaw housing 130 using an installation tool 151. FIG. 16 illustrates both outer races 152a and 152b installed into the yaw housing 130.

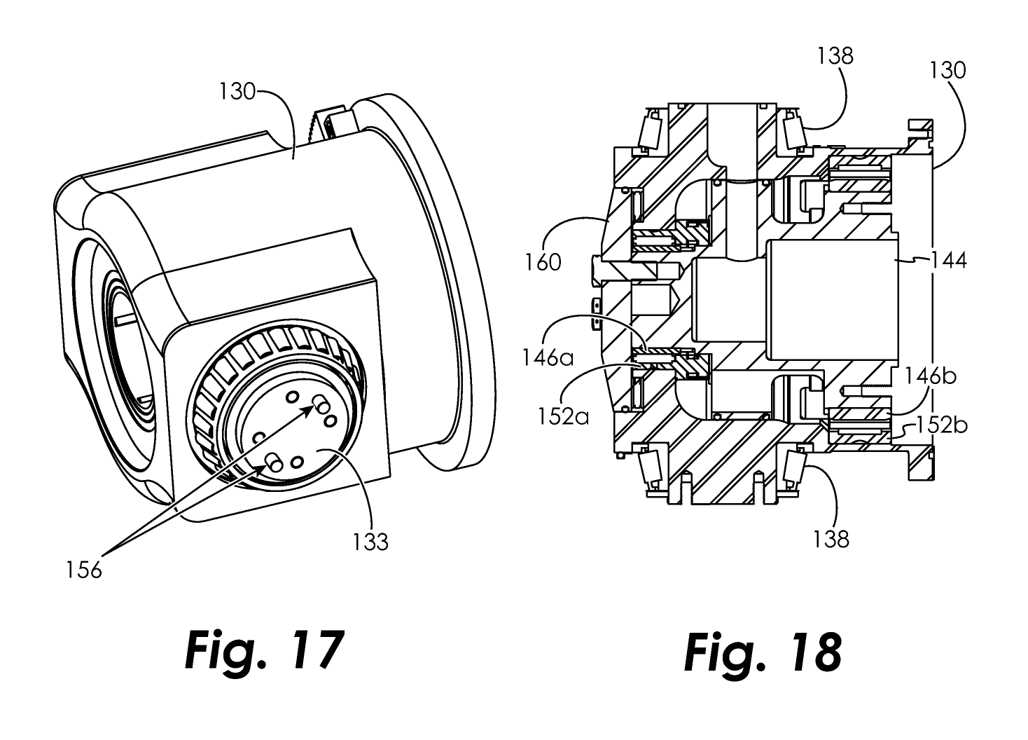

At this stage, dowel pins 156 are inserted into the yaw housing 130, as shown in FIG. 17. Particularly, the dowel pins 156 are inserted into the protrusions 133 formed in a top 134 and a bottom 136 of the yaw housing 130. The roll bearing 144 is installed to the yaw housing 130, as shown in FIG. 18, initially without shims or O-rings installed. The roll bearing 144 is installed so that the inner races 146a and 146b of the roll bearing 144 contact the outer races 152a and 152b, respectively, of the yaw housing 130 allowing the roll bearing 144 to rotate with respect to the yaw housing 130 to allow roll of the system 1000. An endcap 160 is torqued to retain the roll bearing 144 in the yaw housing 130. An end float of the roll bearing 144 is then measured within the housing 130 and the roll bearing 144 is disassembled. Shims may then be ground to achieve approximately 0.001″ tolerance at preload in one embodiment. Due to the tolerance stack up of the parts, a minimum of approximately 0.000″, and a maximum of approximately 0.013″, of material may be required to be ground off the shim in one embodiment.

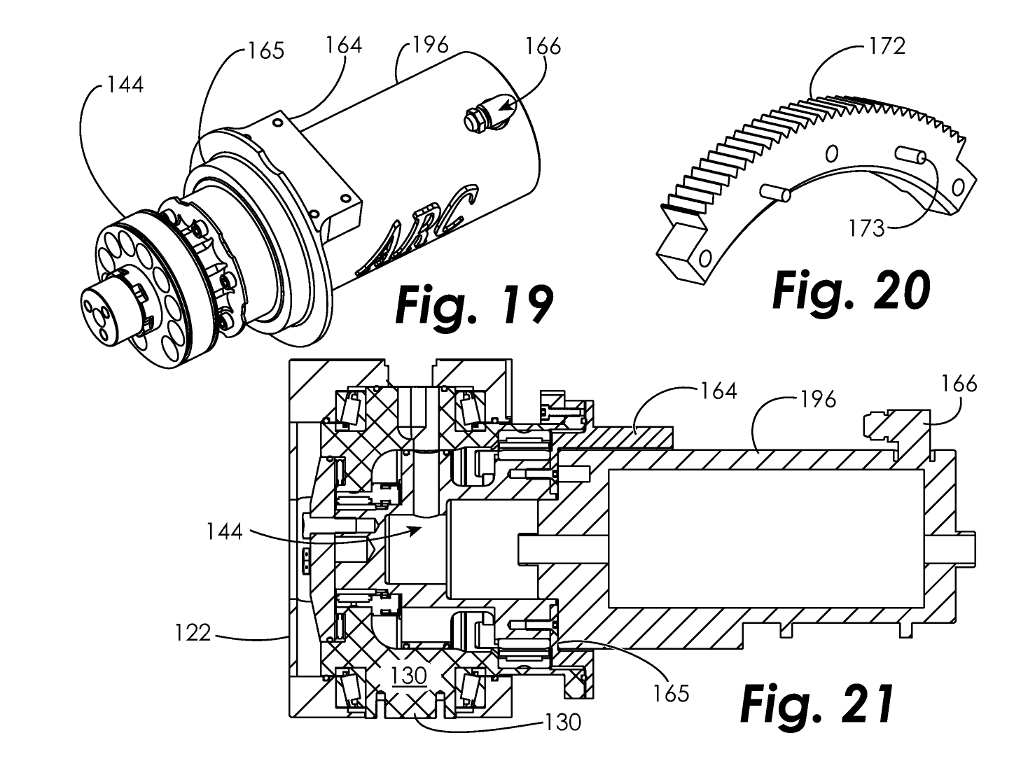

FIGS. 19-27 illustrate further assembly of the system 1000 that enables the system 100C to move both with respect to yaw and roll. As shown in FIGS. 19 and 21, a roll motor carrier 164 is attached to an end 165 of the roll bearing 144 and a force measuring balance 196 is attached to the roll motor carrier 164. The force measuring balance 196 is configured to track the movement of the system 100C with respect to roll, yaw, and pitch. In at least one embodiment, the force measuring balance 196 is attached so that the force measuring balance 196 may be removed without disassembly of the system 100C. The force measuring balance may be aligned during attachment so that a roll shaft airway 166 is oriented approximately 33° clockwise from upright with respect to the yaw housing 130, as shown in FIG. 19. The force measuring balance 196 and roll motor carrier 164 may be attached into the yaw housing 130 with a ground nose cone shim and O-rings installed.

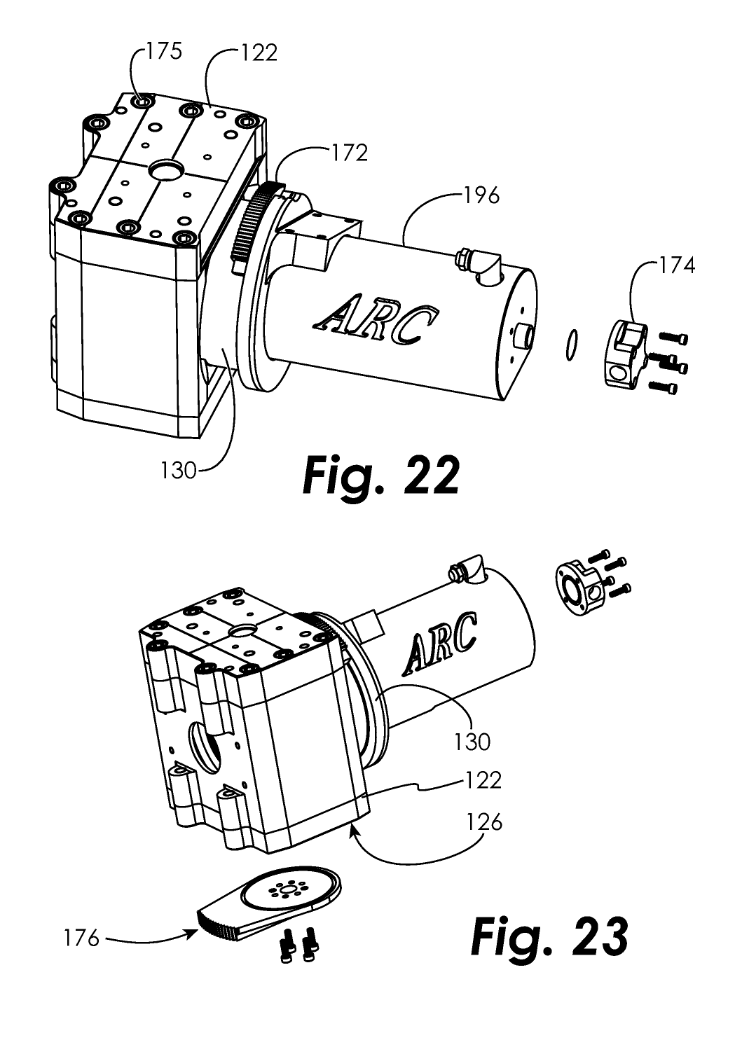

In one embodiment, a roll drive gear 172, shown in FIG. 20, is attached to the yaw housing 130 before the yaw box 122 is re-assembled around the yaw housing 130, as shown in FIG. 22. Before the roll drive gear 172 is attached to the yaw housing 130, dowel pins 173 are inserted into the roll drive gear 172, as shown in FIG. 20. The yaw box 122 may then be re-assembled around the yaw housing 130 with the O-rings installed, as shown in FIG. 21. An air manifold 174 may then be installed as illustrated in FIG. 22.

The yaw box 122 may be assembled using self-locking cap head bolts 175, as shown in FIG. 22. As illustrated in FIG. 23, a yaw drive gear 176 is attached to the bottom 126 of the yaw box 122. The yaw drive gear 176 meshes with the yaw motor pinion gear 184 (described below) to assist in the yaw movement of the system 100C.

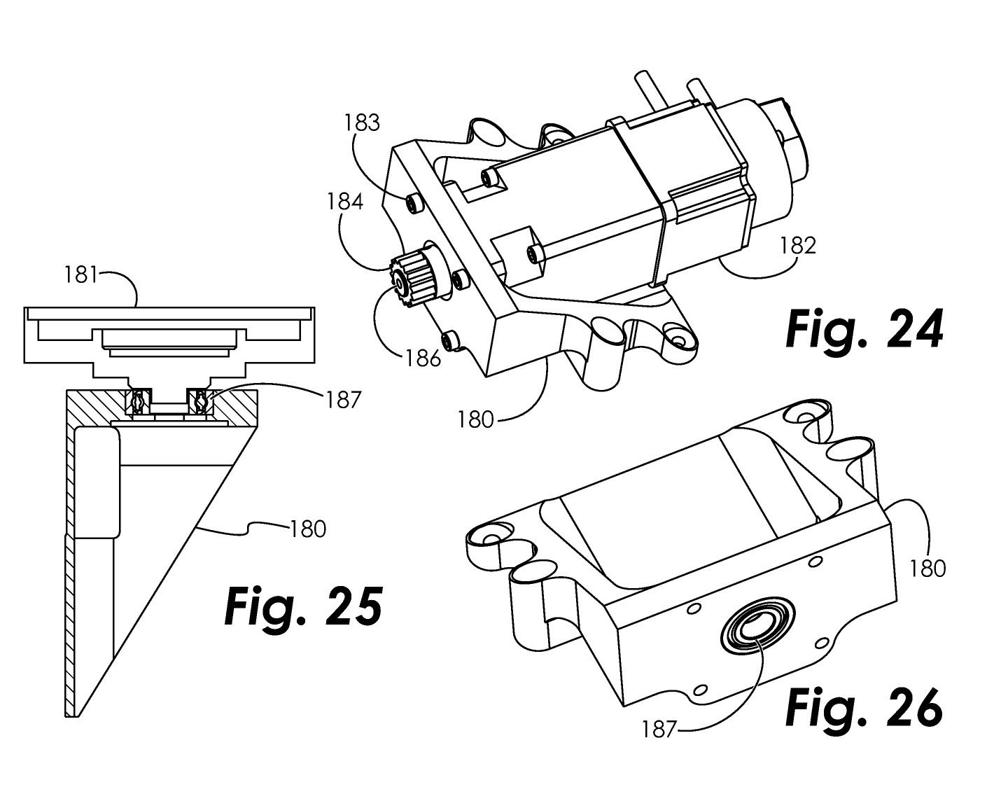

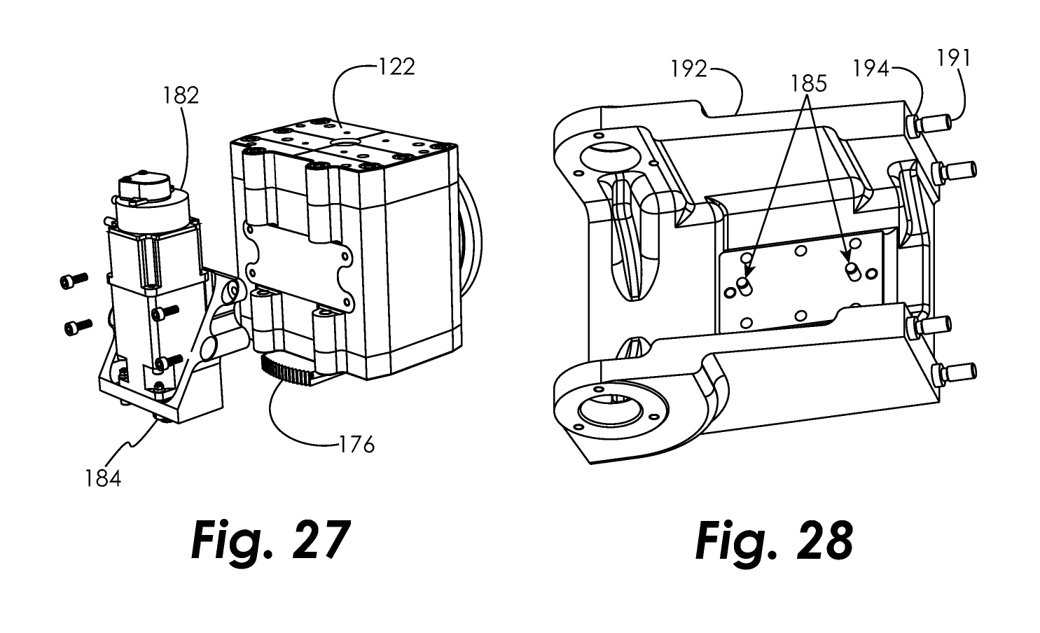

As shown in FIG. 25, a bearing 187 is installed into a yaw motor mount 180 using an installation tool 181. The installed bearing 187 is illustrated in FIG. 26. A yaw motor 182 is then joined to the yaw motor mount 180 using fasteners 183, as illustrated in FIG. 24. A pinion gear 184 is fit to the motor shaft 186 of the yaw motor 182 with the pinion gear 184 abutting the bearing 187. Shims may be used to adjust yaw gear backlash. In one embodiment, backlash is checked in three places across the range of yaw movement: 10°/0°/−10°. As shown in FIG. 27, the yaw motor 182 is installed to the yaw box 122 so that the pinion gear 184 of the yaw motor 182 mates with the yaw drive gear 176 of the yaw box 122 to allow yaw movement of the system 100C.

FIGS. 28-37 illustrate various assemblies for a pitch system. The assemblies vary based on the configuration of the model motion system 100. In particular, the model motion system 100 may be configured as a single seater race car vehicle model or a non-single seater race car vehicle model. FIG. 28 illustrates a cradle 192 that is used with both the single seater and non-single seater models. Dowel pins 191 are pressed into the cradle 192 with lead chamfers 194 exposed. It should be noted that two jacking screw holes 185 are provided to aid in separation of the force measuring balance 196 from the cradle 192.

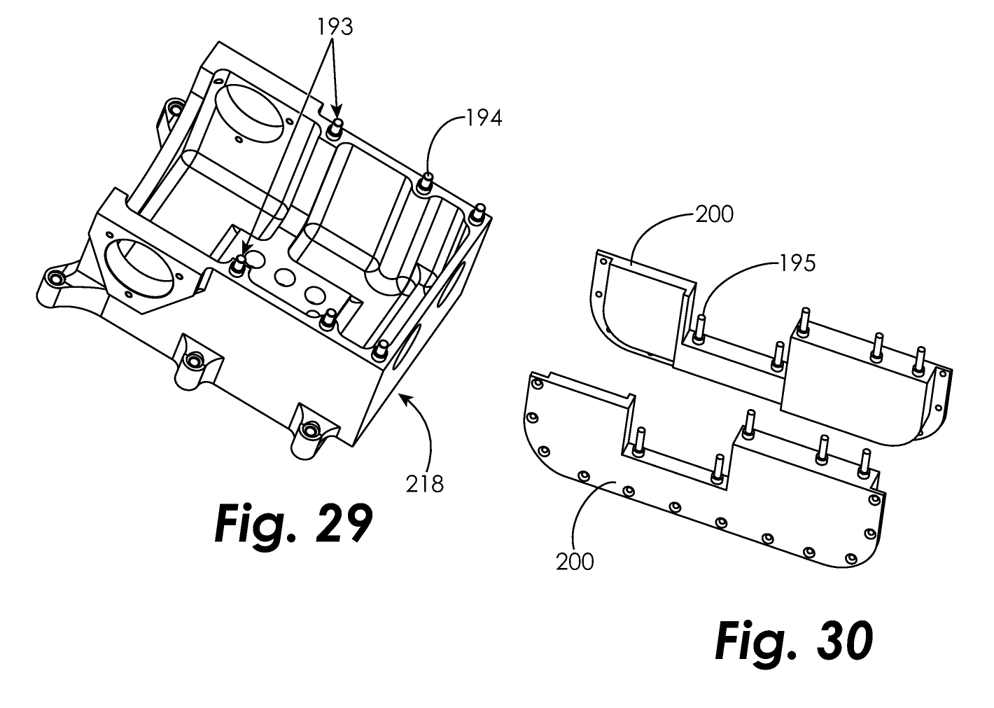

FIG. 29 illustrates a cradle boss 218 utilized to retain the cradle 192 in a non-single seater model. Ring dowels 193 are pressed into the top of the cradle boss 218 with the chamfers 194 exposed. The cradle boss 218 is configured to retain the cradle 192 therein.

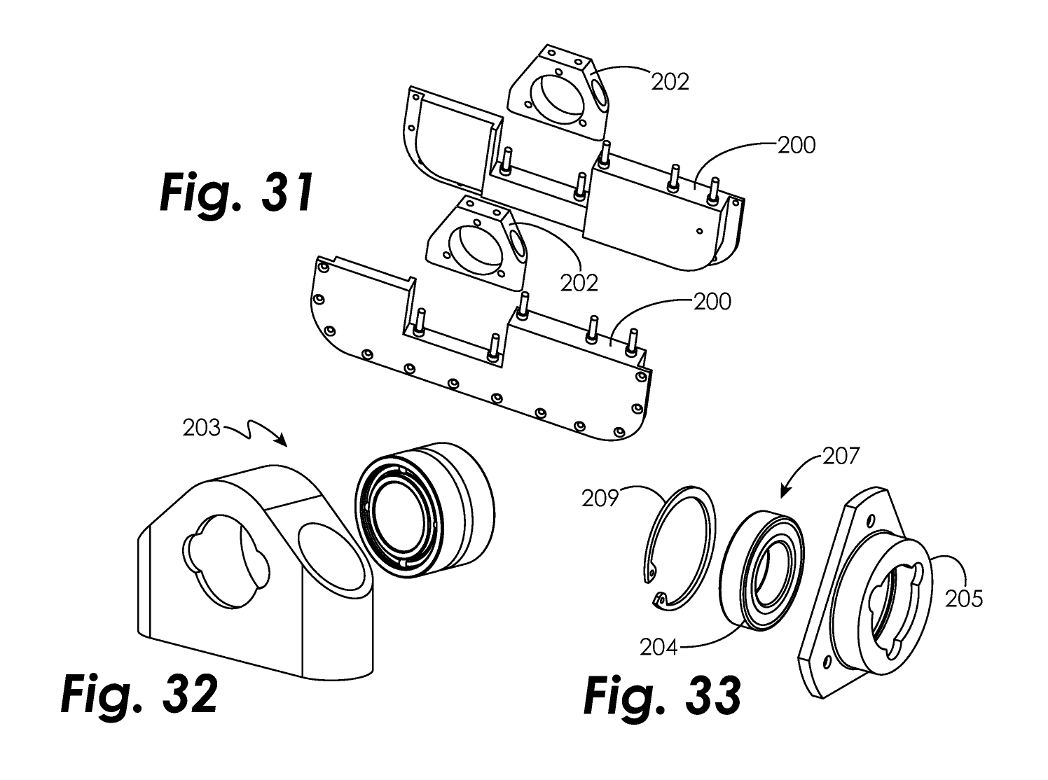

FIG. 30 illustrates spine plates 200 utilized to retain the cradle 192 in a single seater model. In such an embodiment, the spine plates 200 replace the cradle boss 218 used in the non-single seater model. In the exemplary embodiment, dowels 195 positioned within the spline plates 200. Pillow block spines 202 may be attached to each spine plate 200 using integrated washer ‘K’ nuts, as shown in FIG. 31.

FIG. 32 illustrates a bearing assembly 203 used for both single seater and non-single seater models. As described later, four bearing assemblies 203 are utilized in the model motion system 100C. FIG. 33 illustrates a bearing assembly 207 used for both single seater and non-single seater models. A bearing 204 is minimally linished so that it can be inserted into spine bearing housing 205 and secured with approximately 55 mm clips 209. The bearing 204 may be installed into the spine bearing housing 205 using an installation tool 209, as shown in FIG. 36. In a single seater model, the spine bearing housing 205 is freely inserted into the pillow block spines 202 of the spine plates 200. In a non-single seater model, the spine bearing housing 205 is freely inserted into the cradle boss 218, as shown in FIG. 35.

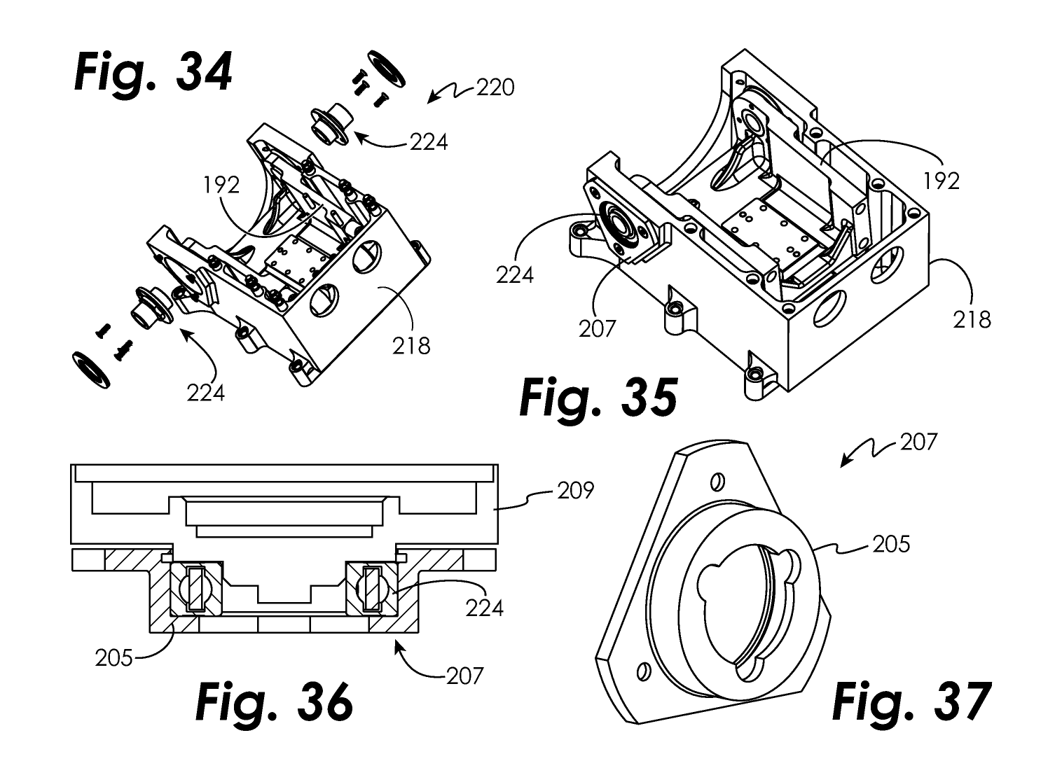

FIGS. 34-37 illustrate the assembly of the cradle 192 into the cradle boss 218 to form a cradle assembly 220, as illustrated in FIG. 34, in a non-single seater model. A cradle mounting boss 224 is installed on each side of the cradle assembly 220. A bearing assembly 207, shown in FIG. 33 and partially in FIG. 37, is installed on each cradle mounting boss 224.

In single-seater race car vehicle model installations, the spine plates 200 are installed to the cradle 192. Using feeler gauges, the gap between each spine plate 200 and the cradle 192 is measured. In one embodiment, due to the tolerance stack up of the parts, the gap may be between approximately 0.000″ and approximately 0.023″.

In non-single-seater race car vehicle model installations, the cradle boss 218 is assembled to the cradle 192. Using feeler gauges, the gap between the cradle boss 218 and the cradle 192 may be measured. In some embodiments, due to the tolerance stack up of the parts, the gap may be between approximately 0.000″ and approximately 0.023″.

Preload adjustments are then made in the installations by reversing the assembly steps and surface grinding the faces of the spine bearing housings 205, shown in FIG. 37, to achieve an approximately 0.001″ tolerance across the thrust bearing assemblies 207. The amount of material to be removed from each spine bearing housing 205 may be between approximately 0.000″ and approximately 0.012″, in one embodiment. An equal amount of material may be removed from both spine bearing housings 205. After grinding, standard bearings are fit into the spine bearing housings 205. It should be noted that the cradle 192 is not re-assembled back into the cradle boss 218 or spine plates 200 at this stage.

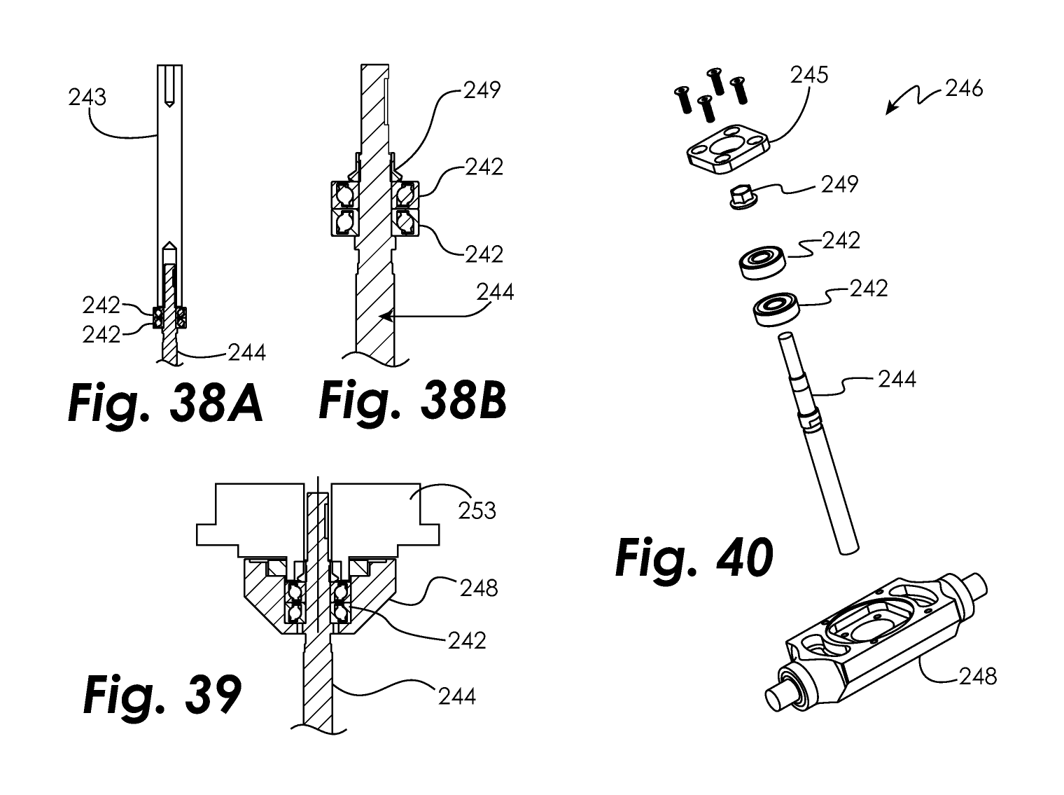

FIGS. 38-43 illustrate a pitch mechanism assembly that provides pitch to the system 100C. In FIG. 38, two bearings 242 are assembled onto a ball screw 244 and seated using an installation tube 243 to form a ball screw/bearing assembly 246. The bearings 242 may be retained with jet nuts 249, as shown in FIG. 40. It should be noted that the bearings 242 should be installed with the thrust races opposing. In FIG. 39, the ball screw/bearing assembly 246 is secured into a pitch motor support 248 using an installation tool 253, and is then secured using a cover plate 245, as shown in FIG. 40. An exploded view of the assembly is shown in FIG. 40.

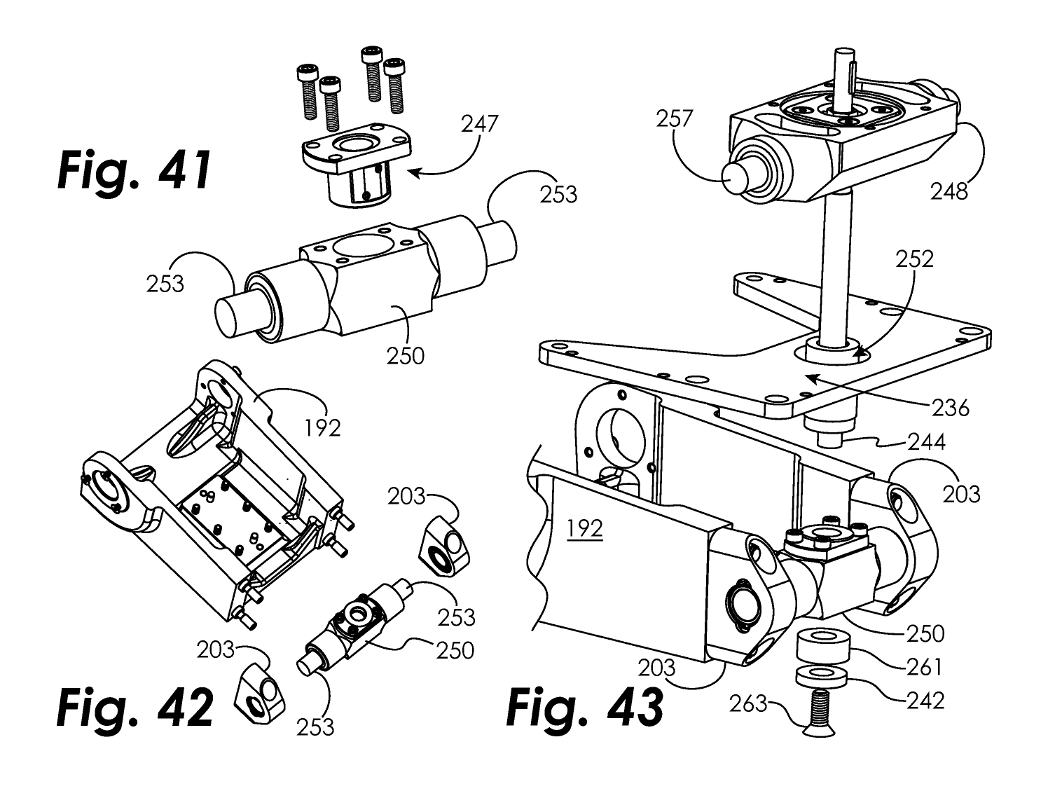

A ball screw nut 247 is inserted into a ball screw nut/gimbal assembly 250, as shown in FIG. 41. As shown in FIG. 42, two bearing assemblies 203, shown in FIG. 32, are slid onto bearing journals 253 of the ball screw nut/gimbal assembly 250 with the bearing retaining flanges 255 facing outwards. This assembly may then be mounted to the cradle 192 using washer ‘K’ nuts, as shown in FIG. 43. The threaded portion of the ball screw shaft 244 is installed through the cradle boss top plate 236 and the pitch upper stop 252. The ball screw 244 is threaded through the ball screw nut/gimbal assembly 250, and the pitch lower stop 261 is positioned over the ball screw 244 and secured with the pitch stop end cap 263.

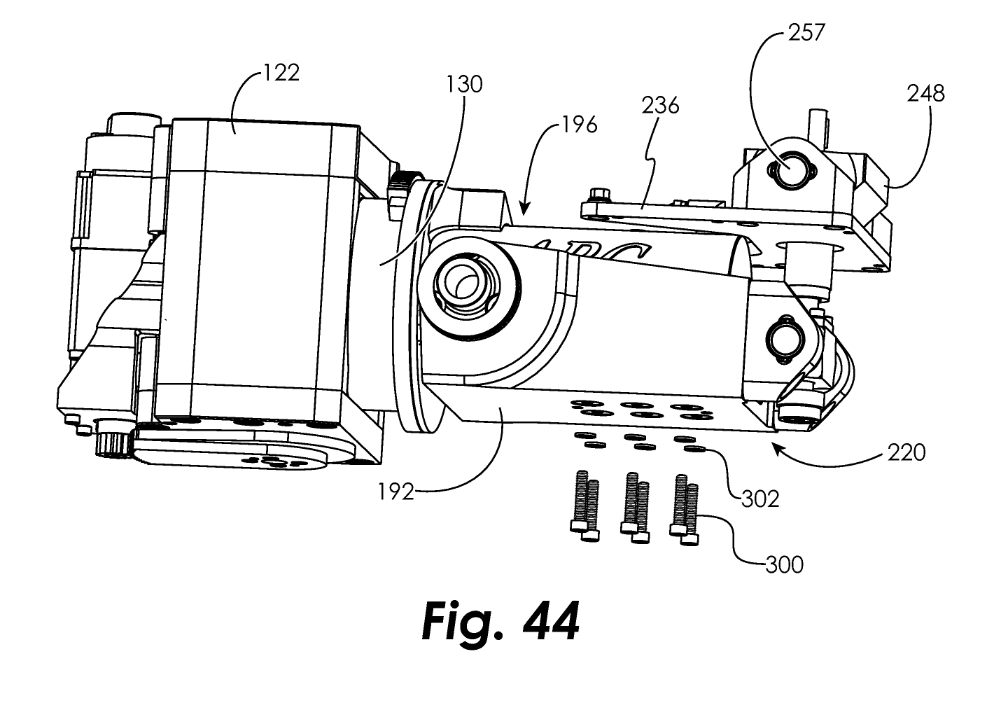

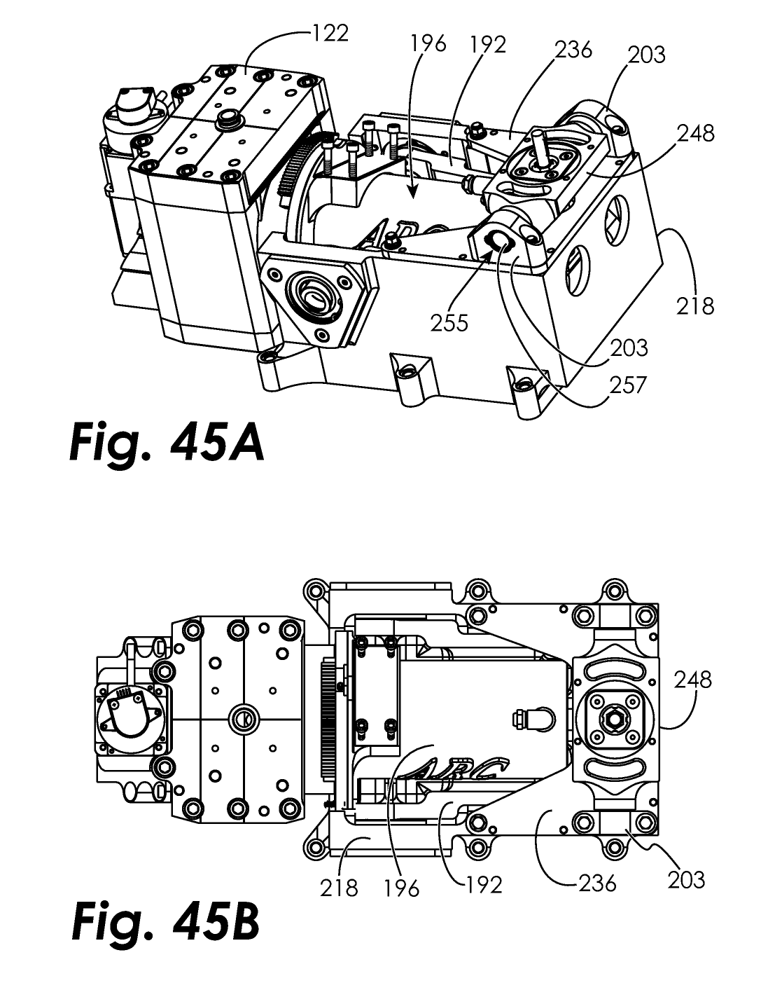

FIGS. 44 and 45 illustrate the pitch system installation of the cradle assembly 220, wherein the cradle 192 may be joined to the force measuring balance 196 with self-locking cap head bolts 300 and washers 302. The cradle boss 218 is then re-assembled to the cradle 192. Two bearing assemblies 203, as shown in FIG. 32 are slid onto the pitch motor support bearing journals 257, with the bearing retaining flanges 255 facing outwards, and the pitch motor support 248 and top plate 236 may be assembled to the cradle boss 218 with integrated washer ‘K’ nuts.

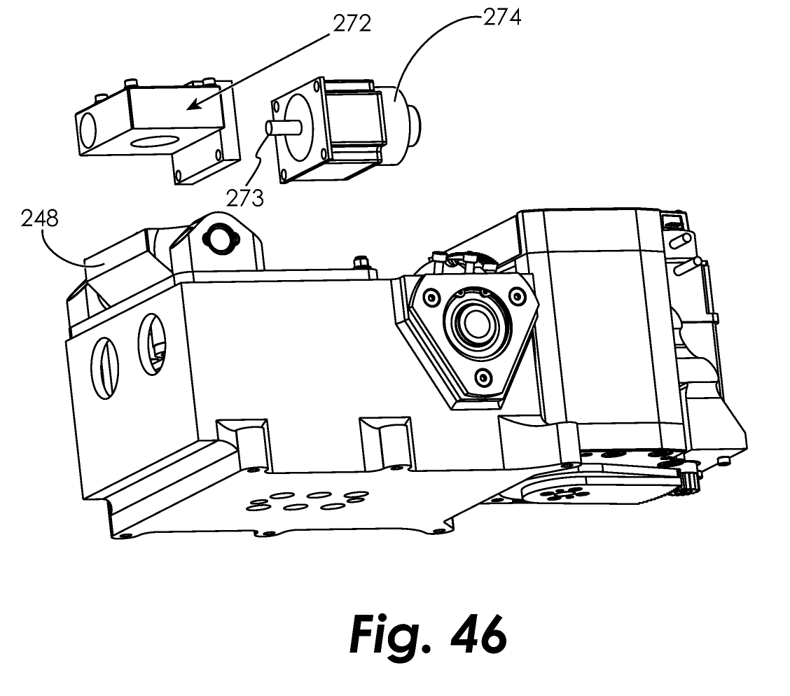

FIG. 46 illustrates a pitch drive installation, wherein a worm gear reducer gearbox 272 may be assembled to the pitch motor support 248 using bolts and washers. A motor 274 may be assembled to the gearbox 272 with self-locking cap head screws. The motor shaft cross-pin 273 engages with drive slots in the gearbox input.

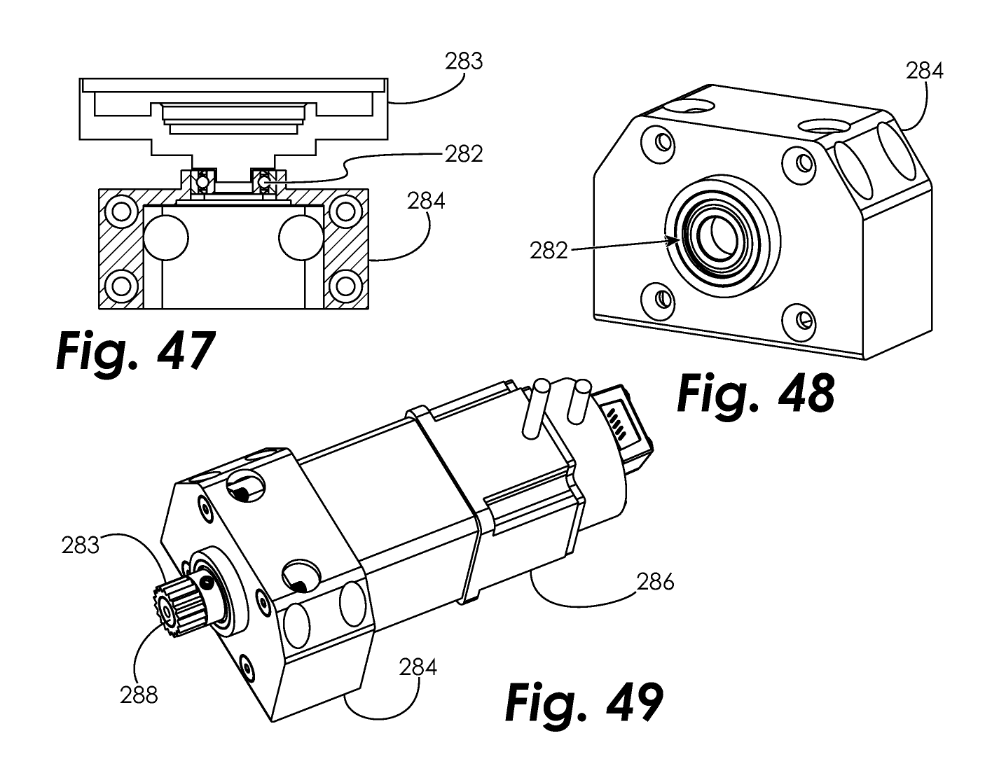

FIGS. 47-50 illustrate a roll drive installation, wherein a bearing 282 is installed into a roll motor mount 284 using an installation tool 283, and a motor/gearbox assembly 286 is joined to the roll motor mount 284 with fasteners. The roll pinion gear 283 is fit to the motor shaft 288 so that the pinion gear 283 abuts the bearing 282. The roll motor mount 284 may be secured to the roll motor carrier 164 using a roll motor/mating bracket 290 such that the roll pinion gear 283 meshes with the roll drive gear 172. One or more shims may be used to adjust the roll gear backlash. The backlash may be checked in three places across the range of roll movement (3°/0°/−3°) in one embodiment.

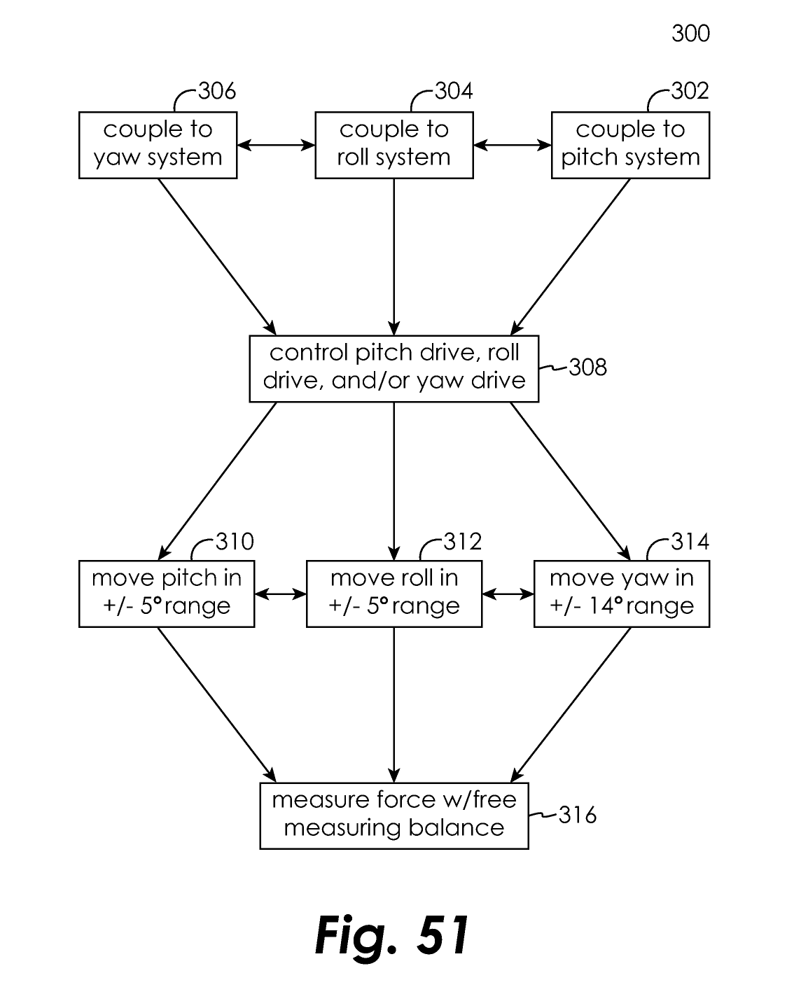

FIG. 51 illustrates the compressed air feed system location to the sting 106, wherein an air spigot 300 is inserted into the top 124 of the yaw box 122. In one embodiment, the air spigot allows the use of a compressed air feed, routed down the sting, so as to allow the option of blown model exhausts, etc. The air spigot 300 provides an attachment location for the sting 106, and is part of the air supply system through the model motion assembly 100C. If the system 100C is installed without the spigot 300, scribed check lines may be provided to aid in alignment of the sting 106.

FIG. 52 illustrates a method 300 for providing controlled motion of a vehicle model. The method 300 includes coupling the vehicle model to a pitch system having a pitch drive, at step 302. The vehicle model is coupled to a roll system having a roll drive, at step 304. The vehicle model is coupled to a yaw system having a yaw drive, at step 306. It should be noted that steps 302, 304, and 306 may occur simultaneously, for example, by coupling the vehicle model to a model motion system having a pitch system, a roll system, and a yaw system. In one embodiment, at least one of the pitch system, the roll system, or the yaw system includes bearings, and the method further includes installing the bearings in a preloaded condition to increase installation stiffness. In one embodiment, at least one of the pitch drive, the roll drive, or the yaw drive includes a stepper motor, and the method further includes driving the stepper motor through gear reduction to multiply torque. In one embodiment, the pitch drive includes a worm-drive gearbox, and the method further includes driving the worm-drive gearbox in a single direction. The method further includes electronically controlling the pitch drive, the roll drive, and/or the yaw drive, at step 308, with a control system to control the respective ranges of motion of the vehicle model with wheels on. In one embodiment, the method includes moving the pitch system within a pitch range of motion of up to +/−5°, at step 310; moving the roll system within a roll range of motion of up to +/−5°, at step 312; and moving the yaw system within a yaw range of motion of up to +/−14°, at step 314. In one embodiment, the respective ranges of motion are achieved either independently or in combination. In one embodiment, the method also includes measuring force on at least one of the pitch system, the roll system, or the yaw system with a force measuring balance, at step 316.

While this disclosure has been described using disclosed embodiments, the systems and methods according to the present disclosure can be further modified within the scope and spirit of this disclosure. This application is therefore intended to cover any variations, uses, or adaptations of the disclosure using its general principles. For example, the methods disclosed herein and in the appended claims represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains and which fall within the limits of the appended claims.

What is claimed is:

1. A model motion system for providing controlled motion of a vehicle model with wheels on comprising:
a pitch system coupled to the vehicle model with wheels on to control a pitch range of motion of the vehicle;
a roll system coupled to the vehicle model with wheels on to control a roll range of motion of the vehicle; and
a yaw system coupled to the vehicle model with wheels on to control a yaw range of motion of the vehicle, wherein the pitch system, the roll system, and the yaw system control respective ranges of motion of the vehicle model with wheels on.

2. The model motion system of claim 1 further comprising a control system electronically coupled to the yaw system, the pitch system, and the roll system.

3. The model motion system of claim 1, wherein the pitch system further comprises a pitch drive.

4. The model motion system of claim 1, wherein the roll system further comprises a roll drive.

5. The model motion system of claim 1, wherein the yaw system further comprises a yaw drive.

6. The model motion system of claim 1, wherein the respective ranges of motion are achieved at least one of independently or in combination.

7. The model motion system of claim 1, wherein forces generated on any of the pitch system, the roll system, or the yaw system during testing limit an amount of deflection of the pitch system, the roll system, and the yaw system.

8. The model motion system of claim 1, further comprising a force measuring balance to measure force on at least one of the pitch system, the roll system, or the yaw system.

9. The model motion system of claim 8, wherein the force measuring balance is removable from the model motion system without complete disassembly of the model motion system.

10. The model motion system of claim 1, wherein the pitch system has a pitch range of motion of up to +/−5°.

11. The model motion system of claim 1, wherein the roll system has a roll range of motion of up to +/−5°.

12. The model motion system of claim 1, wherein the yaw system has a yaw range of motion of up to +/−14°.

13. The model motion system of claim 1, wherein at least one of the pitch system, the roll system, or the yaw system further comprises a stepper motor driving through gear reduction to multiply torque.

14. The model motion system of claim 1, wherein the pitch system further comprises a worm-drive gearbox.

15. The model motion system of claim 1, wherein at least one of the pitch system, the roll system, or the yaw system further comprises bearings that are installed in a preloaded condition to increase installation stiffness.

16. A model motion system for providing controlled motion of a vehicle model with wheels on comprising:
a control system;
a pitch system coupled to the vehicle model with wheels on and having a pitch drive to control a pitch range of motion of the vehicle;
a roll system coupled to the vehicle model with wheels on and having a roll drive to control a roll range of motion of the vehicle; and
a yaw system coupled to the vehicle model with wheels on and having a yaw drive to control a yaw range of motion of the vehicle, wherein the control system electronically controls the pitch drive, the roll drive, and the yaw drive to control the respective ranges of motion of the vehicle model with wheels on.

17. The model motion system of claim 16, wherein the respective ranges of motion are achieved at least one of independently or in combination.

18. The model motion system of claim 16, wherein forces generated on any of the pitch system, the roll system, or the yaw system during testing limit an amount of deflection of the pitch system, the roll system, and the yaw system.

19. The model motion system of claim 16, further comprising a force measuring balance to measure force on at least one of the pitch system, the roll system, or the yaw system, wherein the force measuring balance is removable from the model motion system without complete disassembly of the model motion system.

20. The model motion system of claim 16, wherein the pitch system has a pitch range of motion of up to +/−5°, the roll system has a roll range of motion of up to +/−5°, and the yaw system has a yaw range of motion of up to +/−14°.

21. The model motion system of claim 16, wherein at least one of the pitch drive, the roll drive, or the yaw drive further comprises a stepper motor driving through gear reduction to multiply torque.

22. The model motion system of claim 16, wherein the pitch drive further comprises a worm-drive gearbox.

23. The model motion system of claim 16, wherein at least one of the pitch system, the roll system, or the yaw system further comprises bearings that are installed in a preloaded condition to increase installation stiffness.

24. A method for providing controlled motion of a vehicle model with wheels on comprising:
coupling the vehicle model with wheels on to a pitch system having a pitch drive;
coupling the vehicle model with wheels on to a roll system having a roll drive;
coupling the vehicle model with wheels on to a yaw system having a yaw drive; and
electronically controlling the pitch drive, the roll drive, and the yaw drive with a control system to control the respective ranges of motion of the vehicle model with wheels on.

25. The method of claim 25 further comprising achieving the respective ranges of motion at least one of independently or in combination.

26. The method of claim 25 further comprising measuring force on at least one of the pitch system, the roll system, or the yaw system with a force measuring balance.

27. The model motion system of claim 25 further comprising:
moving the pitch system within a pitch range of motion of up to +/−5°;
moving the roll system within a roll range of motion of up to +/−5°; and
moving the yaw system within a yaw range of motion of up to +/−14°.

28. The method of claim 25, wherein at least one of the pitch drive, the roll drive, or the yaw drive further comprises a stepper motor, the method further comprising driving the stepper motor through gear reduction to multiply torque.

29. The method of claim 25, wherein the pitch drive further comprises a worm-drive gearbox, the method further comprising driving the worm-drive gearbox in a single direction.

30. The method of claim 25, wherein at least one of the pitch system, the roll system, or the yaw system further comprises bearings, the method further comprising installing the bearings in a preloaded condition to increase installation stiffness.
